(19) United States
(12) Patent Application Publication
(10) Pub. No.: US 2020/0070083 A1
(43) Pub. Date: Mar. 5, 2020

(54) A SORBENT AND A FILTER

(71) Applicant: SVENSKA AEROGEL AB, Gävle (SE)

(72) Inventors: Zareh TOPALIAN, Uppsala (SE); Peter NORBERG, Gävle (SE)

(73) Assignee: SVENSKA AEROGEL AB, Gävle (SE)

(21) Appl. No.: 16/609,379

(22) PCT Filed: Apr. 20, 2018
(86) PCT No.: PCT/SE2018/050406

§ 371 Date: Oct. 29, 2019

(30) Foreign Application Priority Data
May 3, 2017 (SE) 1750535-5

(51) Int. Cl. B01D 53/02; B01J 20/10; B01J 20/26; B01J 20/28; B01J 20/32

(52) U.S. Cl. CPC B01D 53/02; B01J 20/103; B01J 20/26; B01J 20/28061; B01D 2257/708; B01D 2253/106; B01D 2253/306; B01D 2258/02; B01J 20/3272

(57) ABSTRACT

A sorbent for capture of ethylene gas includes an amorphous precipitated silica material having a BET surface area of at least 200 m²/g and an organic compound in the form of an amine, an imine or an amide bound to a surface of the amorphous precipitated silica material. The organic compound is configured for chemisorption of ethylene. An ethylene gas filtration system for a refrigerator includes an ethylene gas filter including the sorbent and a fan. The ethylene gas filter is mounted in conjunction with the fan such that gas is actively circulated through the ethylene gas filter by means of the fan. The organic compound may be triisopropanolamine, polyethylenimine or polyamide.

### TECHNICAL FIELD

The present invention relates to a sorbent for capture of ethylene gas. It further relates to an ethylene gas filter comprising such a sorbent, to an ethylene gas filtration system, and to use of the proposed sorbent for capture of ethylene gas.

### BACKGROUND AND PRIOR ART

Recent studies indicate that a large share of economic costs associated with waste generated in the food supply chain occurs in the households at the end of the chain. One source of waste is that fruits and vegetables (fresh produce) stored in domestic refrigerators become deteriorated before consumption and therefore have to be discarded.

Ethylene gas (C₂H₄) is generated naturally by many fruits and vegetables during the ripening process. It can further stimulate ripening and also increase the rate of deterioration of fresh produce. The concentrations at which ethylene can affect fresh produce are very low, and therefore methods for reducing its presence, or equally its effects, may be beneficial in order to prolong the shelf life of fresh produce.

An important remedy to reduce household food waste would consequently be to apply ethylene control technology in association with domestic refrigerators. Some technologies already exist, including absorption of ethylene in the refrigerator by use of an adsorbent package containing potassium permanganate, addition of ozone to the refrigerator to act as an ethylene control agent, and treatment of fresh produce with an ethylene inhibitor in the form of 1-methylcyclopropene.

However, when refrigerator temperatures are well controlled and relatively frequently ventilated by opening and closing the door, the above technologies have been found unlikely to have great benefits. In addition, use of the mentioned chemicals is questionable in environments where food is handled and stored.

### SUMMARY OF THE INVENTION

It is a primary object of the present invention to provide an in at least some aspect improved technology by means of which ethylene gas can be removed from locations in which fresh produce is stored, such as from refrigerators. In particular, it is an object to provide such a technology which can remove ethylene relatively efficiently without having to treat fresh produce with chemicals and without use of hazardous substances such as potassium permanganate. Another object is to provide a sorbent for capture of ethylene gas which can be cost efficiently produced.

According to a first aspect of the invention, at least the primary object is achieved by means of a sorbent for capture of ethylene gas according to claim 1. The sorbent comprises:
an amorphous precipitated silica material having a BET surface area of at least 200 m²/g; and
an organic compound in the form of an amine, an imine or an amide bound to a surface of the amorphous precipitated silica material, wherein the organic compound is configured for chemisorption of ethylene.

Sorbents according to the invention may be used to remove ethylene gas from any environment in which fresh produce is stored. The sorbent may efficiently remove ethylene gas from e.g. a refrigerator by means of chemisorption without the use of potassium permanganate. Thanks to the large BET surface area of the amorphous precipitated silica material, the organic compound which is active in the chemisorption of ethylene can be spread out over a large surface which thereby becomes active in the uptake of ethylene. The sorbent can furthermore be cost efficiently produced by means of mixing alkali silicate with a salt solution followed by ambient pressure drying, such as previously described in WO2006/071183, wherein the organic compound may either be added to the salt solution before precipitation of silica, or to the precipitated silica after washing and dewatering. In both cases, doping of the amorphous precipitated silica with the organic compound can efficiently be included in the production process.

The organic compound should be one which is able to chemically react with ethylene and form a surface bound reaction product, thereby trapping it in the porous structure of the sorbent. Since the organic compound acts so as to chemisorb the ethylene gas, ethylene trapped within the sorbent is not released upon a change in e.g. temperature and/or ethylene gas concentration. According to the present invention, organic compounds in the form of amides, imines or amines have been found to be suitable for this purpose when bound to the surface of the amorphous precipitated silica material. Preferably, the sorbent comprises no other organic compound than said organic compound in the form of an amide, an imine or an amine.

According to one embodiment, the amorphous precipitated silica material has a BET surface area of at least 300 m²/g, preferably of at least 400 m²/g. The relatively large BET surface area is beneficial for the adsorption efficiency of the sorbent and increases the ethylene uptake.

According to one embodiment, the amorphous precipitated silica material is a mesoporous material comprising agglomerates of porous particles according to the formula Me_{y}O×m SiO₂, wherein Me denotes any two or more metals selected among Ca, Mg, Cu, Zn, Mn, Cd, Pb, Ni, Fe, Cr, Al, Ti, V, Co, Mo, Sn, Sb, Sr, Ba and W, y denotes the molar ratio of metallic constituents to oxygen, and m denotes the molar ratio of SiO₂/Me_{y}O. A method of manufacturing such an amorphous precipitated silica material has been previously described in WO2006/071183. The precipitated silica material according to this formula is known to have a relatively large BET surface area and can be manufactured with suitable pore sizes within the mesoporous range, i.e. 2-50 nm. The value of m may vary between 1-4, or preferably 2-3.7, such as m=3.35. The value of y may vary within the range 0.5-2, depending on the valences of the metals.

According to one embodiment, Me denotes Ca and Mg. A combination of Ca and Mg has proved to give good results in terms of BET surface area, pore size distribution and dopability of the silica material with the organic compound. The molar ratio of Ca/Mg may e.g. be 35/65 or 32/68, but the molar ratio may of course be optimised to achieve a desired dopability with the selected organic compound. Preferably, the molar ratio of Ca/Mg varies within the range 0.05<Ca/Mg<1.0.

According to one embodiment, the organic compound is present within the sorbent in an amount of 1-20 wt. %, preferably in an amount of 2-12 wt. %, and more preferably in an amount of 5-10 wt. %. Here, the amount is given in percentage by weight (wt. %) of dry matter of the total sorbent weight. By including at least 1 wt. %, preferably at least 2 wt. % and more preferably at least 5 wt. %, desirable levels of ethylene adsorption may be achieved. By limiting the amount to 20 wt. %, preferably 12 wt. % and more preferably 10 wt. %, negative effects on the BET surface area, the pore size and the mechanical strength of the sorbent can be avoided.

According to one embodiment, the organic compound is a polyamide. Sorbents including polyamide (PA) have been found to show promising results in terms of ethylene capture. Polyamides in this case include aliphatic polyamides such as nylon 6 ((C₆H₁₁NO)ₙ) and nylon 6,6, etc. The sorbent can in this embodiment be cost efficiently produced by adding PA to the salt solution before mixing with the alkali silicate solution and subsequent precipitation of silica. Doping of the amorphous precipitated silica with the organic compound can thereby efficiently be included in the production process without additional drying steps.

According to one embodiment, the organic compound is triisopropanolamine. Sorbents including triisopropanolamine (TIPA) show very promising results in terms of ethylene capture in comparison with e.g. potassium permanganate based sorbents.

According to one embodiment, the organic compound is polyethylenimine. Sorbents including polyethylenimine (PEI) show promising results in terms of ethylene capture. Preferably, in this embodiment, the sorbent comprises an amount of 10-20 wt. % of polyethylenimine.

The invention also relates to an ethylene gas filter for a refrigerator comprising the proposed sorbent in accordance with any of the above described embodiments. The ethylene gas filter may comprise a gas permeable carrier for holding the sorbent. The refrigerator may be a domestic or a commercial refrigerator.

Another objective of the invention is to achieve an improved ethylene uptake in refrigerators in comparison with passive ethylene gas sinks. This objective is achieved by an ethylene gas filtration system for a refrigerator according to claim 10. The ethylene gas filtration system comprises the proposed ethylene gas filter mounted in conjunction with a fan such that gas is actively circulated through the ethylene gas filter by means of the fan. The fan may e.g. be an evaporator fan adapted to blow air across evaporator coils of the refrigerator and distribute it throughout the interior of the refrigerator in a more efficient way than via natural convection.

According to the invention, the fan is used in combination with the proposed ethylene gas filter, comprising a sorbent according to any one of the above described embodiments, to make the uptake of ethylene much more efficient than by using merely passive adsorption. By recirculating the interior air of the refrigerator through the filter, several refrigerator volumes of air can pass through the filter, and thereby the uptake of unwanted ethylene generated by fresh produce stored in the refrigerator can be improved.

The present disclosure also relates to use of the proposed sorbent according to any one of the above described embodiments for capture of ethylene gas. Preferably, but not exclusively, the disclosure relates to use of the sorbent for capture of ethylene gas in a refrigerator.

Further advantages as well as advantageous features of the present invention will appear from the following detailed description.

### BRIEF DESCRIPTION OF THE DRAWINGS

Embodiments of the invention will in the following be described with reference to the appended drawings, in which:

FIG. 1 shows removal efficiency of sorbents according to embodiments of the invention as a function of time for an ethylene gas concentration of 200 ppm, and

FIG. 2 shows removal efficiency of sorbents according to an embodiment of the invention for an ethylene gas concentration of 10 ppm as a function of time.

### DETAILED DESCRIPTION OF EMBODIMENTS OF THE INVENTION

A sorbent for capture of ethylene gas according to an embodiment of the invention comprises an amorphous precipitated silica material having the general formula Me_{y}O×m SiO₂, wherein Me denotes any two or more metals selected among Ca, Mg, Cu, Zn, Mn, Cd, Pb, Ni, Fe, Cr, Al, Ti, V, Co, Mo, Sn, Sb, Sr, Ba and W, y denotes the molar ratio of metallic constituents to oxygen, and m denotes the molar ratio of SiO₂/Me_{y}O. The amorphous precipitated silica material may be in the form of a Quartzene® material of CMS type, which can be written as (Ca_{0.35}, Mg_{0.65})O×3.35 SiO₂, i.e. Me=(Ca_{0.35}, Mg_{0.65}), y=1 and m=3.35.

A method of manufacturing this material by mixing alkali silicate with a salt solution is disclosed in WO 2006/071183. The material is formed as a precipitate by mixing alkali silicate with a salt solution. The precipitate is thereafter processed in various ways to obtain an end product having desired properties in terms of pore size, particle size, surface area, density, etc. The amorphous precipitated silica material used for the sorbent according to embodiments of the invention has a mesoporous structure with a BET surface area of at least 200 m²/g, preferably of at least 300 m²/g or more preferably of at least 400 m²/g.

The amorphous precipitated silica material is doped with an organic compound in the form of an amine, an imine or an amide bound to a surface of the amorphous precipitated silica material, wherein the organic compound is configured for chemisorption of ethylene. The organic compound may preferably be in the form of triisopropanolamine (TIPA), but also polyamide (PA) and polyethylenimine (PEI) have been found to be beneficial for the capture of ethylene gas. The organic compound is preferably present within the sorbent in an amount of 1-20 wt. %, more preferably in an amount of 2-12 wt. %, and even more preferably in an amount of 5-10 wt. %. However, this depends on e.g. which organic compound is used, the method of doping, the available BET surface area of the amorphous precipitated silica material as well as the pore size of this material.

The sorbent according to the invention may advantageously be included in an ethylene gas filter placed in a refrigerator, intended to remove ethylene gas from the internal environment of the refrigerator. The sorbent may for this purpose be supported on a gas permeable carrier, such as in a filter cassette. The ethylene gas filter may preferably form part of an ethylene gas filtration system for a refrigerator, which apart from the ethylene gas filter comprises a fan, such as an evaporator fan of the refrigerator. The ethylene gas filter is in this case located either upstream or downstream of the fan such that air containing ethylene gas is actively circulated through the ethylene gas filter by means of the fan. When air containing ethylene gas at low concentrations, such as at 1-10 ppm, passes through the ethylene gas filter, the ethylene gas becomes chemisorbed by the sorbent and is thereby removed from the internal environment of the refrigerator.

### EXAMPLES

A number of exemplary ethylene sorbents according to embodiments of the invention, S1-S4, were manufactured and tested together with reference prior art sorbents, Ref1-Ref3. The tested sorbents are listed in Table I.

TABLE I

| | | Density | Ethylene uptake |
|---|---|---|---|
| Sample | Description | (g/cm³) | (mg/g sorbent) |
| S1 | 10 wt. % TIPA on | 0.57 | 4.34 |
| | precipitated silica | | |
| S2 | 5 wt. % PA on | 0.57 | 0.85 |
| | precipitated silica | | |
| S3 | 20 wt. % PEI on | 0.40 | 1.28 |
| | precipitated silica | | |
| S4 | 40 wt. % PEI on | 0.40 | 2.25 |
| | precipitated silica | | |
| Ref1 | Commercial carbon | 0.11 | 1.22 |
| | filter (Electrolux) | | |
| Ref2 | Activated carbon | 0.43 | 1.43 |
| | (Jacobi) | | |
| Ref3 | Activated carbon | 0.43 | 1.32 |
| | (Silcarbon Aktivkohle) | | |

The amorphous precipitated silica material of S1-S4 was a CMS type Quartzene® material. The sorbents S1, S3 and S4 were prepared in accordance with the method described in WO 2006/071183, wherein calcium and magnesium sources were added to a dilute active aqueous sodium silicate solution. A salt solution comprising MgCl₂ and CaCl₂ was prepared at a ratio of 68 mol % Mg and 32 mol % Ca. The salt solution was poured onto the 1.5 M (with respect to SiO₂) sodium silicate solution, and the resulting mixture was agitated at room temperature. Subsequent coagulation occurred and the slurry formed was thereafter washed and dewatered on a filter cloth by means of vacuum suction to become a cake or gel. A dilute solution comprising one of TIPA and PEI, was added to the obtained gel. After thorough mixing, the doped gel was dried to obtain the sorbent in powder or granular form.

The sorbent S2 containing PA was prepared according to a somewhat different scheme. In this case, PA was initially dissolved in a methanol/CaCl₂ solution according to a method previously described in B. Sun, “Study on the mechanism of nylon 6, 6 dissolving process using CaCl₂/MeOH as the solvent”, Chinese Journal of Polymer Science, vol. 12 p. 57, 1994. The methanol/CaCl₂ solution comprising PA was thereafter, as a first step, mixed with the sodium silicate solution, resulting in precipitation of amorphous silica doped with PA. Subsequently, the MgCl₂ solution was added to the mixed solution to make the reaction complete. The gel could thereafter be washed, filtered and dried to obtain sorbent in powder or granular form.

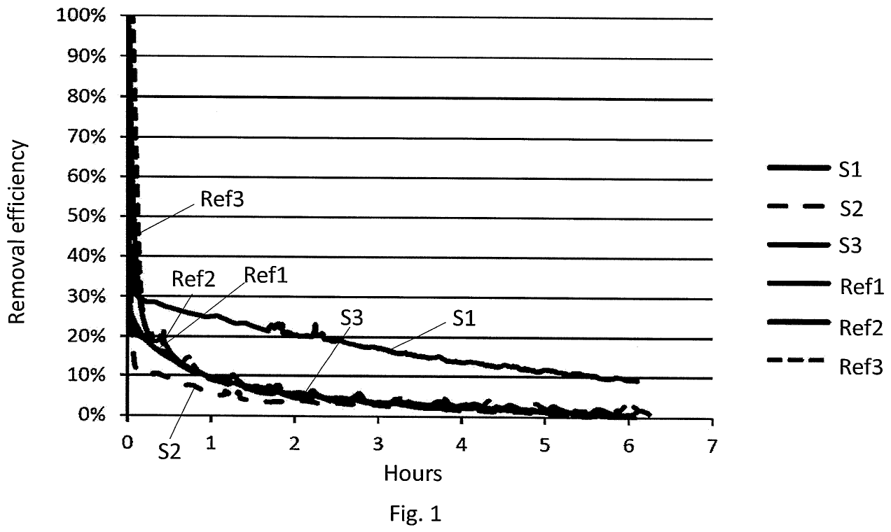

The sorbents listed in Table I were divided into samples of 3 g each. The samples S1-S3 and Ref1-Ref3 were thereafter tested in a first test run by passing air containing 200 ppm ethylene gas through the samples at a temperature of 7° C. and a relative humidity of 70% RH. The temperature and relative humidity resemble the conditions in a refrigerator, but the ethylene concentration can normally be expected to be much lower in a refrigerator, such as of the order of 1 ppm. The volume flow of air was 0.9 l/min. The removal efficiency in percent as a function of time is shown in FIG. 1. As can be seen from the graph in FIG. 1, the sorbent 51 comprising 10 wt. % of TIPA has under these conditions a removal efficiency that is significantly higher than the other samples over time. After one hour, the removal efficiency is approximately 25%, after two hours approximately 20% and after six hours approximately 10%. Thus, after six hours, this sorbent still has capacity left. The other sorbents all show similar removal efficiencies.

The total uptake in mg ethylene during the first test run at 200 ppm ethylene for the different sorbents is shown in Table I. The total uptake is highest for the sample 51 containing 10 wt. % of TIPA, and is also relatively high for the sample S4 containing 40 wt. % of PEI.

Some of the samples were further tested by passing air containing 10 ppm of ethylene gas through the samples at a temperature of 7° C. and at varying relative humidity concentrations of 70% RH, 50% RH and 18% RH. The results are shown in table II, listing uptake in mg ethylene per gram sorbent. For the sorbent 51 comprising 10 wt. % of TIPA, the total ethylene uptake is 0.30 mg ethylene per gram sorbent for 70% RH, 0.34 mg per gram sorbent for 50% RH and 0.04 mg per gram sorbent for 18% RH. In other words, the sorbent S1 comprising TIPA needs a certain amount of relative humidity to function optimally. A comparison between the sorbents S1, S2 comprising PA and Ref3 at an ethylene concentration of 10 ppm and a relative humidity of 50% RH shows that the total uptake is highest for the sorbent 51 containing TIPA (0.034 mg per gram sorbent), followed by the sorbent S2 containing PA (0.05 mg per gram sorbent), while the total uptake of the reference sorbent Ref3 is much lower (0.004 mg per gram sorbent) at this concentration, in spite of a slightly higher ethylene uptake than sample S2 at 200 ppm ethylene.

TABLE II

| | 10 ppm at | 10 ppm at | 10 ppm at |
|---|---|---|---|
| Sample | 70% RH | 50% RH | 18% RH |
| S1 | 0.30 | 0.34 | 0.04 |
| S2 | | 0.05 | |
| S4 | 0.04 | | |
| Ref3 | | 0.004 | |

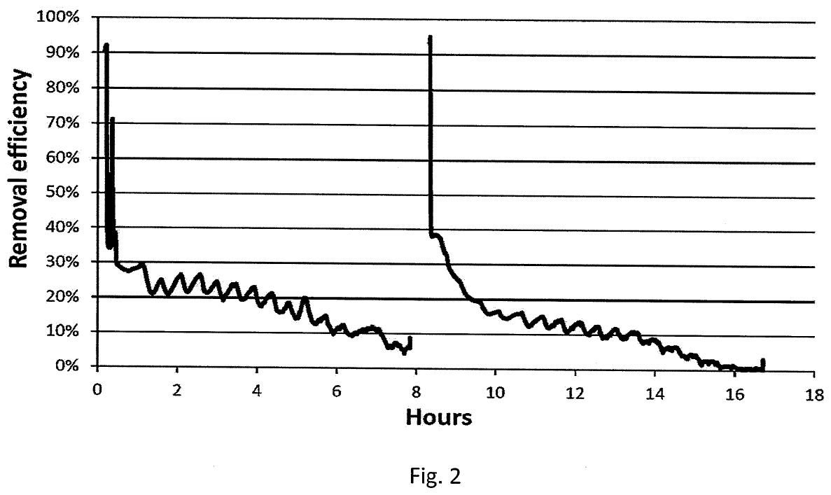

It was also tested whether the sorbent 51 comprising 10% of TIPA can be reused by letting the sorbent rest between two test runs with 10 ppm ethylene gas at 50% RH and at 7° C. The first test run resulted in a 22% weight loss, which was attributed to water loss. Following a resting period of 17 days, a corresponding amount of water was added to the sorbent to compensate for the weight loss and the sorbent was thereafter subjected to a second test run under the same conditions. The results are shown in FIG. 2, showing removal efficiency as a function of time for the two test runs. It was found that the sorbent worked nearly as good in the second test run as in the first test run.

To summarize, the experimental results show that all sorbents S1-S4 can function for capture of ethylene gas at conditions similar to those in a refrigerator.

The invention is of course not in any way restricted to the embodiments described above. On the contrary, many possibilities to modifications thereof will be apparent to a person with ordinary skill in the art without departing from the basic idea of the invention such as defined in the appended claims.

1. A sorbent for capture of ethylene gas, comprising:
an amorphous precipitated silica material having a BET surface area of at least 200 m²/g; and
an organic compound in the form of an amine, an imine or an amide bound to a surface of the amorphous precipitated silica material, wherein the organic compound is configured for chemisorption of ethylene.

2. The sorbent according to claim 1, wherein the amorphous precipitated silica material has a BET surface area of at least 300 m²/g.

3. The sorbent according to claim 1, wherein the amorphous precipitated silica material is a mesoporous material comprising agglomerates of porous particles according to the formula Me_{y}O×m SiO₂, wherein Me denotes any two or more metals selected among Ca, Mg, Cu, Zn, Mn, Cd, Pb, Ni, Fe, Cr, Al, Ti, V, Co, Mo, Sn, Sb, Sr, Ba and W, y denotes the molar ratio of metallic constituents to oxygen, and m denotes the molar ratio of SiO₂/Me_{y}O.

4. The sorbent according to claim 3, wherein Me denotes Ca and Mg.

5. The sorbent according to claim 1, wherein the organic compound is present within the sorbent in an amount of 1-20 wt. %.

6. The sorbent according to claim 1, wherein the organic compound is a polyamide.

7. The sorbent according to claim 1, wherein the organic compound is triisopropanolamine.

8. The sorbent according to claim 1, wherein the organic compound is polyethylenimine.

9. An ethylene gas filter for a refrigerator comprising the sorbent according to claim 1.

10. An ethylene gas filtration system for a refrigerator, comprising the ethylene gas filter according to claim 9 and a fan, wherein the ethylene gas filter is mounted in conjunction with the fan such that gas is actively circulated through the ethylene gas filter by means of the fan.

11. A method comprising using the sorbent according to claim 1 for capture of ethylene gas.

12. The sorbent according to claim 1, wherein the amorphous precipitated silica material has a BET surface area of at least 400 m²/g.

13. The sorbent according to claim 1, wherein the organic compound is present within the sorbent in an amount of 2-12 wt. %.

14. The sorbent according to claim 1, wherein the organic compound is present within the sorbent in an amount of 5-10 wt. %.

15. The sorbent according to claim 2, wherein the amorphous precipitated silica material is a mesoporous material comprising agglomerates of porous particles according to the formula Me_{y}O×m SiO₂, wherein Me denotes any two or more metals selected among Ca, Mg, Cu, Zn, Mn, Cd, Pb, Ni, Fe, Cr, Al, Ti, V, Co, Mo, Sn, Sb, Sr, Ba and W, y denotes the molar ratio of metallic constituents to oxygen, and m denotes the molar ratio of SiO₂/Me_{y}O.

16. The sorbent according to claim 2, wherein the organic compound is present within the sorbent in an amount of 1-20 wt. %.

17. The sorbent according to claim 3, wherein the organic compound is present within the sorbent in an amount of 1-20 wt. %.

18. The sorbent according to claim 4, wherein the organic compound is present within the sorbent in an amount of 1-20 wt. %.

19. The sorbent according to claim 2, wherein the organic compound is a polyamide.

20. The sorbent according to claim 3, wherein the organic compound is a polyamide.
